(19) United States
(12) Patent Application Publication
(10) Pub. No.: US 2018/0184616 A1
(43) Pub. Date: Jul. 5, 2018

(54) Pest Free Pet Feeder

(71) Applicant: Hugo Gerardo Duran-Jimenez, San Bernardino, CA (US)

(72) Inventor: Hugo Gerardo Duran-Jimenez, San Bernardino, CA (US)

(21) Appl. No.: 15/860,457

(22) Filed: Jan. 2, 2018

Related U.S. Application Data
(60) Provisional application No. 62/441,473, filed on Jan. 2, 2017.

(51) Int. Cl. A01K 5/01; A01K 7/00

(52) U.S. Cl. CPC A01K 5/0142; A01K 7/00

(57) ABSTRACT

A pest free pet feeder that prevents pests from accessing animal food intended for consumption by house pets, includes a food bowl, an elevation stand, a first water bowl, and a second water bowl. The food bowl is supported above the first water bowl and the second water bowl by the elevation stand, wherein the elevation stand is mounted into the first water bowl and the second water bowl. The first water bowl and the second water bowl are filled with water, wherein the water prevents pests from crawling up the elevation stand and into the food bowl and the food contained therein. The food bowl includes a food basin and a basin retainer ring, wherein the basin retainer ring is mounted to the elevation stand and the food basin is supported within the basin retainer ring. The food basin can be removed for cleaning or refilling.

The current application claims a priority to the U.S. Provisional Patent application Ser. No. 62/441,473 filed on Jan. 2, 2017.

### FIELD OF THE INVENTION

The present invention relates generally to animal feeding devices. More specifically, the present invention is an elevated food bowl that is supported by a pair of water bowls that act to deter pests from crawling into the food bowl, while simultaneously providing drinking water to a pet.

### BACKGROUND OF THE INVENTION

A variety of animals often serve as domestic house pets. While there are many benefits to owning domestic house pets, they require varying amounts care. Chief among the tasks necessary for proper pet care are regular feeding and providing drinking water. A variety of pet foods must be fed to animals at regular intervals throughout the day. To aid in containing the mess often associated with feeding domestic pets, a variety of food bowls are commonly utilized. Such bowls serve to keep pet food off the floor while providing easy pet access to the food.

However, most pet bowls are not optimized for use in all situations. Many pet food bowls are placed directly on the ground. This is not ideal, as it allows opportunity for pests to crawl into the food bowl. In addition, larger animals may not enjoy laying down or craning their necks to eat their food. To this end, a variety of elevated food bowls have been devised that remove the food bowl from the floor. Such food bowls do provide a more convenient eating angle for the animal; however, they do not prevent pests from entering the food supply of the animal, while simultaneously providing drinking water for the pet. What is needed is a food bowl that prevents pests from entering contained pet food. What is further desirable, is a pet bowl that is easy to fill and clean.

Therefore it is an object of the present invention to provide a pest free pet feeder that prevents pests from accessing animal food intended for consumption by house pets. The present invention includes a food bowl, an elevation stand, a first water bowl, and a second water bowl, wherein the food bowl is supported above the first water bowl and the second water bowl by the elevation stand. The elevation stand is mounted into the first water bowl and the second water bowl, while the food bowl is then mounted on top of the elevation stand. The first water bowl and the second water bowl are filled with water, wherein the water prevents pests from crawling up the elevation stand and into the food bowl and the food contained therein. Furthermore, the food bowl includes a food basin that can be removed from a basin retainer ring that cradles and supports the food basin. This enables the user to remove the food basin in order to wash and fill it for the pet.

### BRIEF DESCRIPTION OF THE DRAWINGS

FIG. 1 is a front right perspective view of the present invention.

FIG. 2 is a front left perspective view of the present invention.

FIG. 3 is a top plan view of the present invention.

FIG. 4 is a front elevational view of the present invention.

FIG. 5 is a rear elevational view of the present invention.

FIG. 6 is a right side elevational view of the present invention.

FIG. 7 is a left side elevational view of the present invention.

FIG. 8 is a perspective view of the present invention, showing the food basin removed from the basin retainer ring.

FIG. 9 is a perspective view of the elevation stand.

FIG. 10 is a bottom perspective view, showing the plurality of leg mounts integrated into the basin retainer ring.

### DETAIL DESCRIPTIONS OF THE INVENTION

All illustrations of the drawings are for the purpose of describing selected versions of the present invention and are not intended to limit the scope of the present invention.

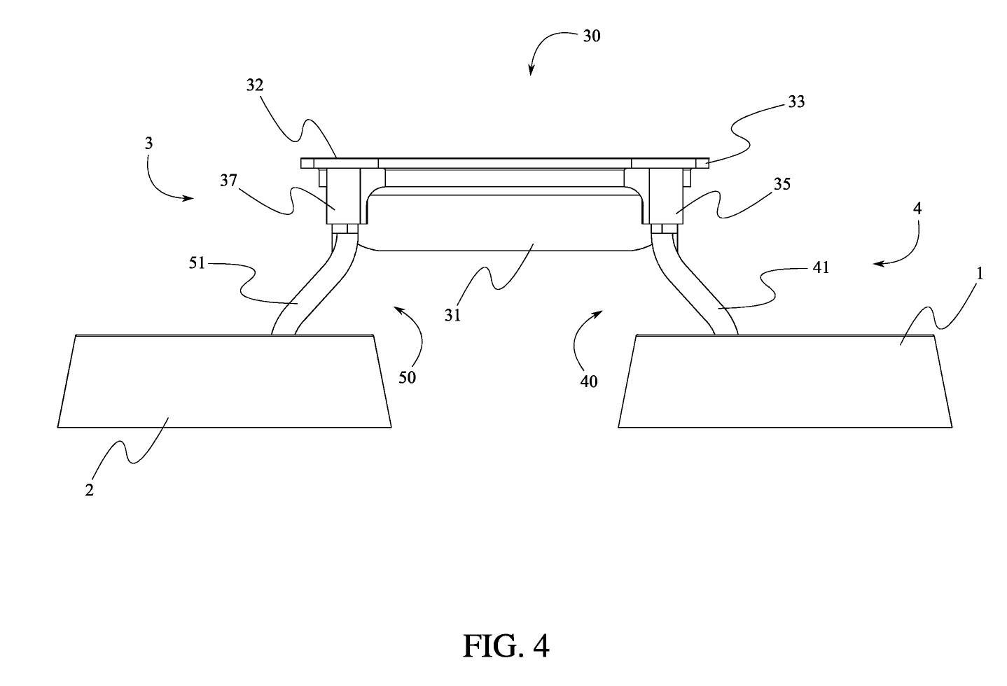

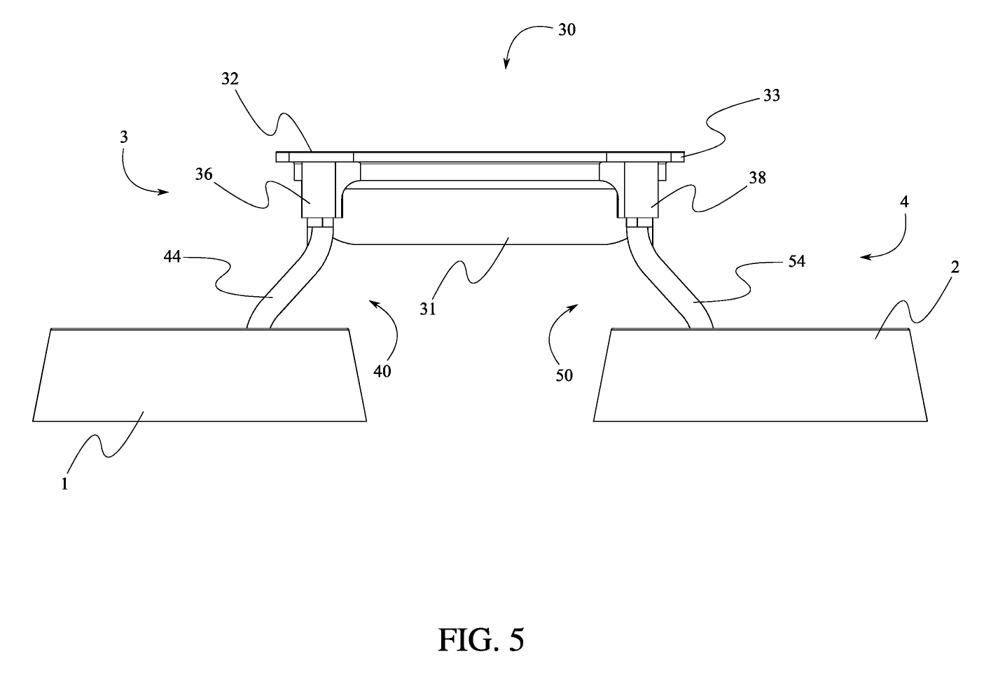

The present invention is a pest free pet feeder that provides drinking water and food for house pets, while also preventing pests from accessing the animal food intended for consumption by the pet. In reference to FIG. 4-5, the present invention comprises a first water bowl 1, a second water bowl 2, a food bowl 3, and an elevation stand 4. The elevation stand 4 is mounted within the first water bowl 1 and the second water bowl 2, and provides an elevated support to raise the food bowl 3 off of the ground. Meanwhile, the first water bowl 1 and the second water bowl 2 are filled with water that is both intended for the pet to drink and to prevent crawling pests such as ants, cockroaches, termites, spiders, etc., from accessing food in the food bowl 3.

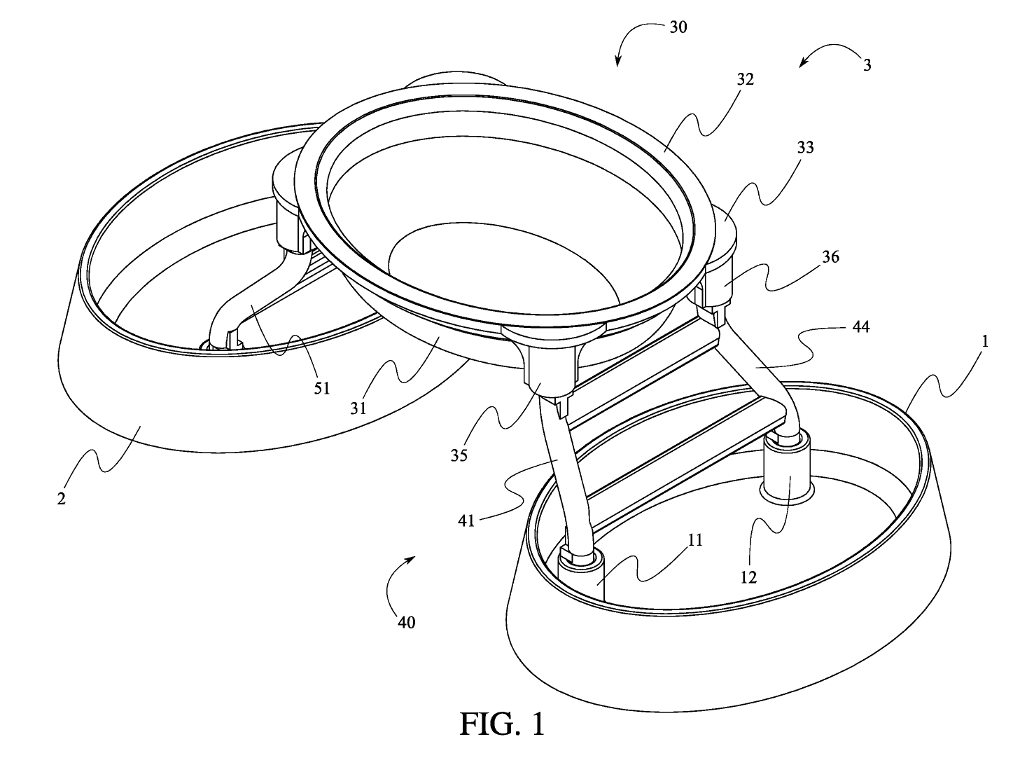

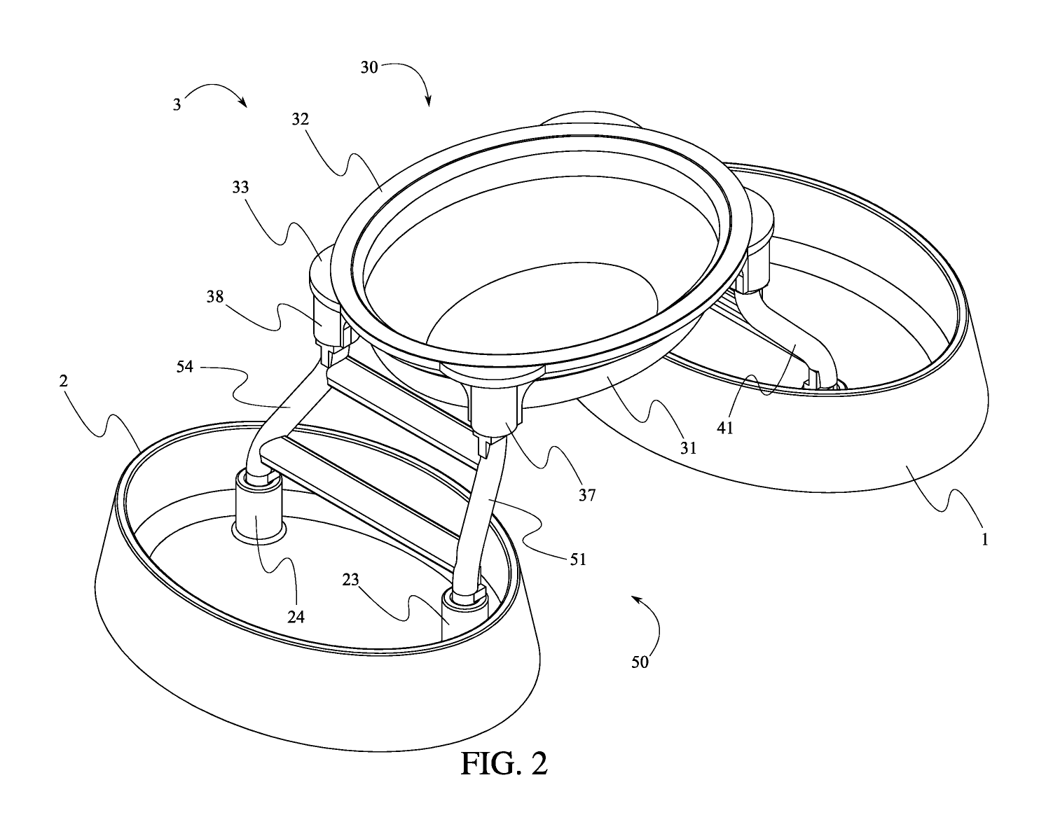

The first water bowl 1 and the second water bowl 2 are positioned on a resting surface, such as the floor, wherein the first water bowl 1 and the second water bowl 2 support both the elevation stand 4 and the food bowl 3. In reference to FIG. 4-5, the elevation stand 4 comprises a first leg structure 40 and a second leg structure 50 for supporting opposing sides of the food bowl 3. The first leg structure 40 is positioned into the first water bowl 1, wherein the first water bowl 1 is terminally connected to the first leg structure 40, as depicted in FIG. 1. The first leg structure 40 extends upwards, out from the first water bowl 1, wherein the first leg structure 40 extends above the top rim of the first water bowl 1. Similarly, the second leg structure 50 is positioned into the second water bowl 2, wherein the second water bowl 2 is terminally connected to the second leg structure 50, as depicted in FIG. 2. The second leg structure 50 extends upwards, out from the second water bowl 2, wherein the second leg structure 50 extends above the top rim of the second water bowl 2.

In reference to FIG. 4-5, the food bowl 3 is attached to the elevation stand 4 opposite the first water bowl 1 and the second water bowl 2, wherein the food bowl 3 is elevated off of the resting surface. More specifically, the food bowl 3 is terminally attached to the first leg structure 40, opposite the first water bowl 1, and terminally attached to the second leg structure 50, opposite the second water bowl 2. The first leg structure 40 and the second leg structure 50 are positioned opposite each other about the food bowl 3, such that the food bowl 3 is evenly supported and the weight of the food bowl 3 is evenly distributed through the first leg structure 40 and the second leg structure 50. Furthermore, the food bowl 3 is positioned in between the first water bowl 1 and the second water bowl 2. The widened stance of the first water bowl 1 and the second water bowl 2 provides increased stability to prevent the food bowl 3 from toppling over if inadvertently struck.

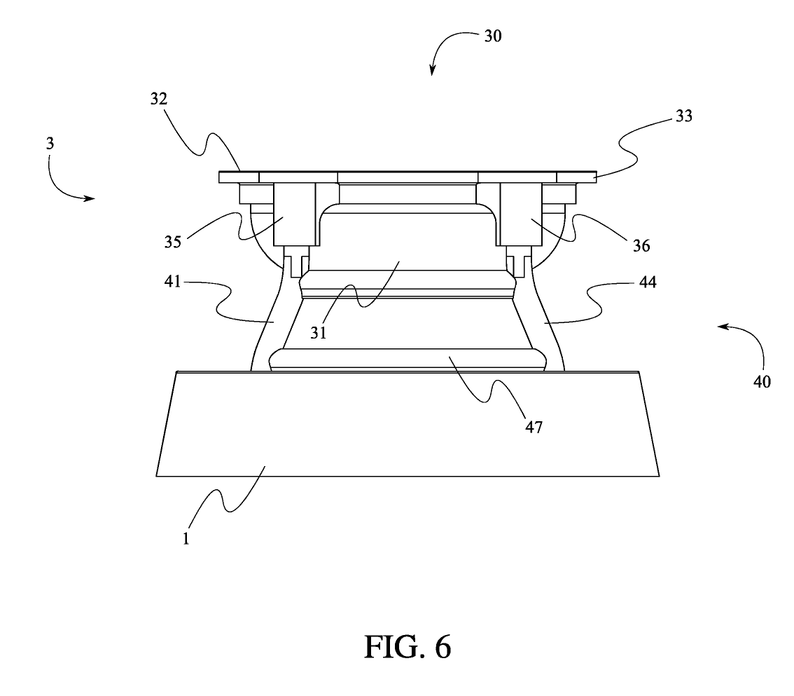

In reference to FIG. 6, in the preferred embodiment of the present invention, the first leg structure 40 comprises a first upright 41, a second upright 44, and a first bridge 47. The first upright 41 and the second upright 44 provide the vertical members of the first leg structure 40, while the first bridge 47 provides at least one horizontal member to bind the first upright 41 and the second upright 44 together. As such, the first upright 41 and the second upright 44 are terminally connected to the first bridge 47, wherein the first upright 41 and the second upright 44 are positioned opposite each other along the first bridge 47. The first bridge 47 stabilizes the position of the first upright 41 and the second upright 44 in relation to one another, such that neither the first upright 41 nor the second upright 44 is able to rotate, or otherwise be displaced, irrespective of the other.

Both the first upright 41 and the second upright 44 are elongated bodies that have an S-curve shape. When mounted to the first water bowl 1, the first upright 41 and the second upright 44 extend upwards, out of the first water bowl 1, and then curve inwards, towards the second water bowl 2, as depicted in FIG. 4-5. The first upright 41 and the second upright 44 then proceed to curve upwards to engage with the food bowl 3. The curved nature of the first upright 41 and the second upright 44 offsets the food bowl 3 from the first water bowl 1, creating a wider base for improved stability of the present invention. Furthermore, the first upright 41 and the second upright 44 are angled in relation to one another, such that the first leg structure 40 is tapered towards the food bowl 3 as depicted in FIG. 6, again creating a widened base to support the food bowl 3.

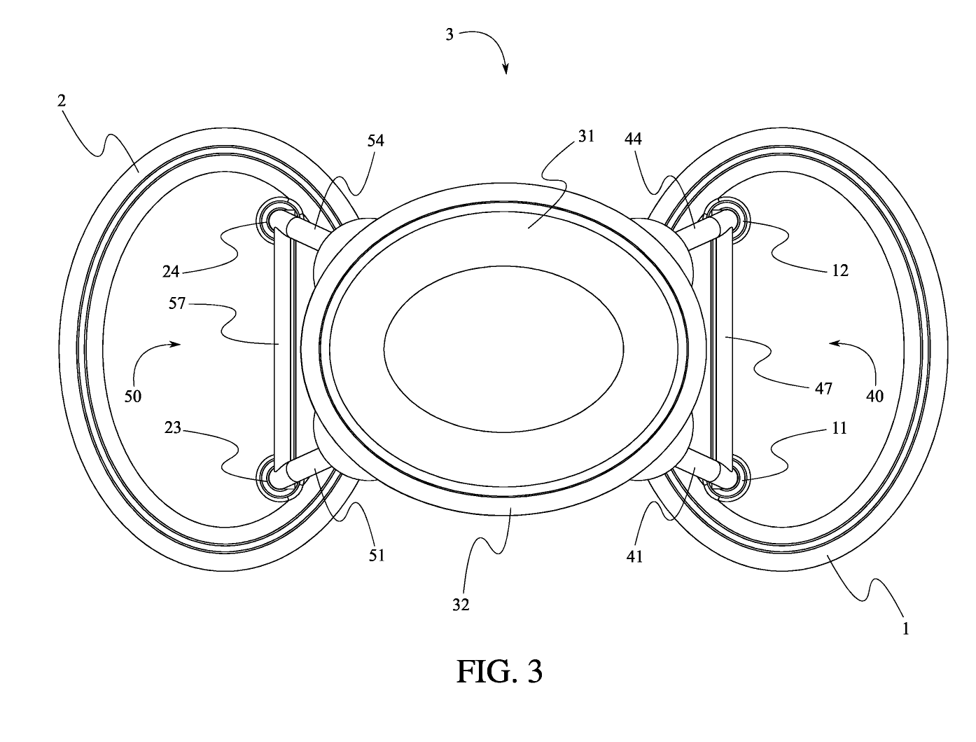

Further in accordance to the preferred embodiment of the present invention and in reference to FIG. 1, the first water bowl 1 comprises a first leg retainer 11 and a second leg retainer 12, which serve as mounting points for the first leg structure 40. The first leg retainer 11 and the second leg retainer 12 are tubular extrusions stemming from the base of the concave portion of the first water bowl 1 and are designed to receive the first upright 41 and the second upright 44 respectively. In reference to FIG. 3, the first water bowl 1 is formed into an oval shape, wherein the first leg retainer 11 and the second leg retainer 12 are longitudinally offset from each other. The offset nature of the first leg retainer 11 from the second leg retainer 12 creates a widened support base for the first leg structure 40, thus providing greater stability to prevent the food bowl 3 from being tipped over.

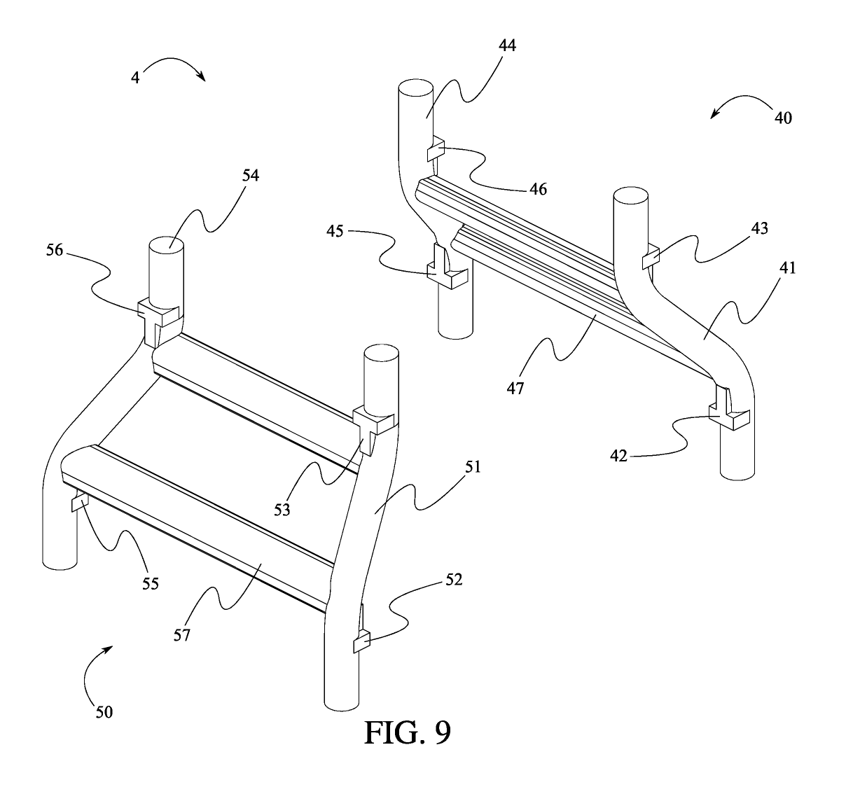

In reference to FIG. 1, the first upright 41 is positioned into the first leg retainer 11, while the second upright 44 is positioned into the second leg retainer 12. In some embodiments of the present invention, the first upright 41 comprises a first retainer stop 42, while the second upright 44 comprises a second retainer stop 45, as depicted in FIG. 9. The first retainer stop 42 is an extrusion that is offset from the end of the first upright 41 that is inserted into the first leg retainer 11. As the first upright 41 is positioned into the first leg retainer 11, the first retainer stop 42 engages with the top of the first leg retainer 11, preventing the first upright 41 from being inserted any further. Similarly, the second retainer stop 45 is an extrusion that is offset from the end of the second upright 44 that is inserted into the second leg retainer 12. As the second upright 44 is positioned into the second leg retainer 12, the second retainer stop 45 engages with the top of the second leg retainer 12, preventing the second upright 44 from being inserted any further.

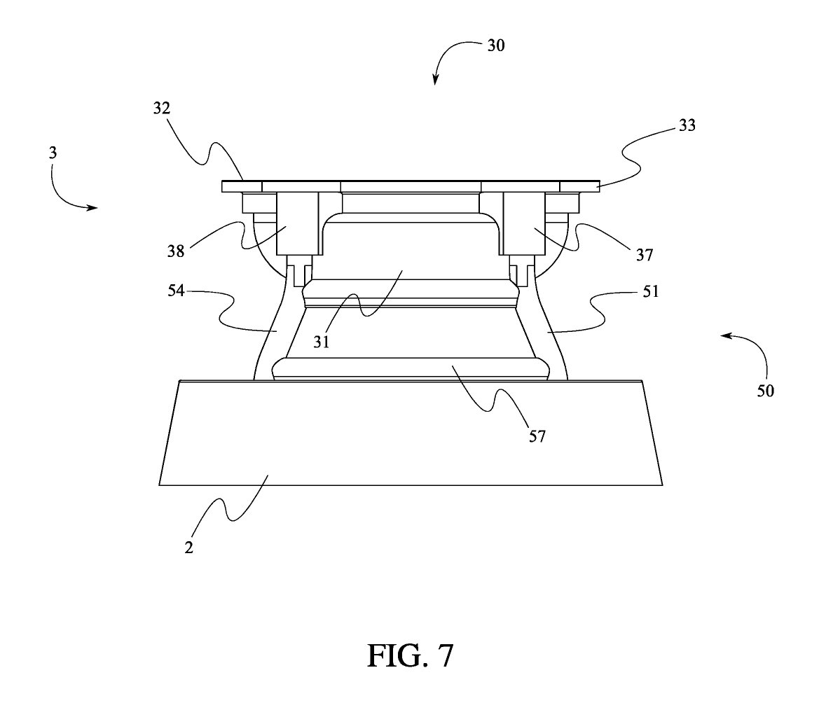

Similar to the first leg structure 40 and in reference to FIG. 7, in the preferred embodiment of the present invention the second leg structure 50 comprises a third upright 51, a fourth upright 54, and a second bridge 57. The third upright 51 and the fourth upright 54 provide the vertical members of the second leg structure 50, while the second bridge 57 provides at least one horizontal member to bind the third upright 51 and the fourth upright 54 together. As such, the third upright 51 and the fourth upright 54 are terminally connected to the second bridge 57, wherein the third upright 51 and the fourth upright 54 are positioned opposite each other along the second bridge 57. The second bridge 57 stabilizes the position of the third upright 51 and the fourth upright 54 in relation to one another, such that neither the third upright 51 nor the fourth upright 54 is able to rotate, or otherwise be displaced, irrespective of the other.

Both the third upright 51 and the fourth upright 54 are elongated bodies that have an S-curve shape. When mounted to the second water bowl 2, the third upright 51 and the fourth upright 54 extend upwards, out of the second water bowl 2, and then curve inwards, towards the first water bowl 1, as depicted in FIG. 4-5. The third upright 51 and the fourth upright 54 then proceed to curve upwards to engage with the food bowl 3. The curved nature of the third upright 51 and the fourth upright 54 offsets the food bowl 3 from the second water bowl 2, creating a wider base for improved stability of the present invention. Furthermore, the third upright 51 and the fourth upright 54 are angled in relation to one another, such that the second leg structure 50 is tapered towards the food bowl 3 as depicted in FIG. 7, again creating a widened base to support the food bowl 3.

Further in accordance to the preferred embodiment of the present invention and in reference to FIG. 2, the second water bowl 2 comprises a third leg retainer 23 and a fourth leg retainer 24, which serve as mounting points for the second leg structure 50. The third leg retainer 23 and the fourth leg retainer 24 are tubular extrusions stemming from the base of the concave portion of the second water bowl 2 and are designed to receive the third upright 51 and the fourth upright 54 respectively. In reference to FIG. 3, the second water bowl 2 is formed into an oval shape, wherein the third leg retainer 23 and the fourth leg retainer 24 are longitudinally offset from each other. The offset nature of the third leg retainer 23 from the fourth leg retainer 24 creates a widened support base for the second leg structure 50, thus providing greater stability to prevent the food bowl 3 from being tipped over.

In reference to FIG. 2, the third upright 51 is positioned into the third leg retainer 23, while the fourth upright 54 is positioned into the fourth leg retainer 24. In some embodiments of the present invention, the third upright 51 comprises a third retainer stop 52, while the fourth upright 54 comprises a fourth retainer stop 55, as depicted in FIG. 9. The third retainer stop 52 is an extrusion that is offset from the end of the third upright 51 that is inserted into the third leg retainer 23. As the third upright 51 is positioned into the third leg retainer 23, the third retainer stop 52 engages with the top of the third leg retainer 23, preventing the third upright 51 from being inserted any further. Similarly, the fourth retainer stop 55 is an extrusion that is offset from the end of the fourth upright 54 that is inserted into the fourth leg retainer 24. As the fourth upright 54 is positioned into the fourth leg retainer 24, the fourth retainer stop 55 engages with the top of the fourth leg retainer 24, preventing the fourth upright 54 from being inserted any further.

Furthermore, in the preferred embodiment of the present invention, the first leg retainer 11 and the second leg retainer 12 are offset from the longitudinal centerline of the first water bowl 1 as depicted in FIG. 3, wherein the first leg retainer 11 and the second leg retainer 12 are positioned between the longitudinal centerline and the second water bowl 2. As such, the first leg structure 40 is oriented towards the medial side of the first water bowl 1. Meanwhile, the lateral side of the first water bowl 1 provides an expanded support area, creating a widened base area for the present invention. Similarly, the third leg retainer 23 and the fourth leg retainer 24 are offset from the longitudinal centerline of the second water bowl 2 as depicted in FIG. 3, wherein the third leg retainer 23 and the fourth leg retainer 24 are positioned between the first water bowl 1 and the longitudinal centerline of the second water bowl 2. As such, the second leg structure 50 is oriented towards the medial side of the second water bowl 2. Meanwhile, the lateral side of the second water bowl 2 provides an expanded support area, creating a widened base area for the present invention.

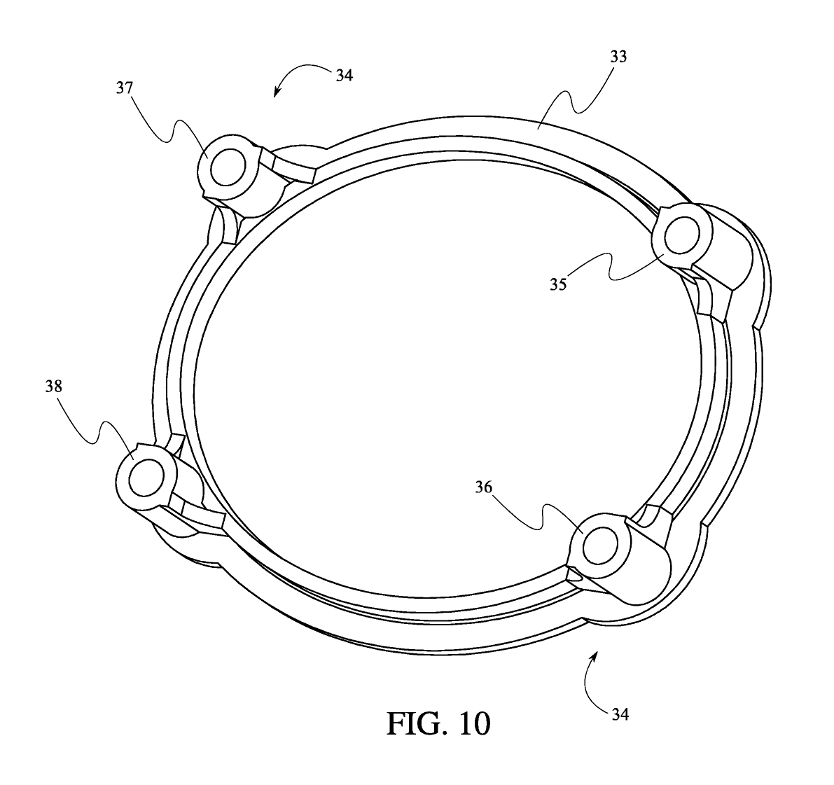

The food bowl 3 is mounted onto the elevation stand 4, such that the food bowl 3 is elevated above the first water bowl 1 and the second water bowl 2, as depicted in FIG. 4. The food bowl 3 comprises a plurality of leg mounts 34, wherein the plurality of leg mounts 34 provides a means of attachment to the elevation stand 4; more specifically, to the first leg structure 40 and the second leg structure 50. In the preferred embodiment of the present invention, the plurality of leg mounts 34 consists of a first leg mount 35, a second leg mount 36, a third leg mount 37, and a fourth leg mount 38. Each of the first leg mount 35, the second leg mount 36, the third leg mount 37, and the fourth leg mount 38 are tubular extrusions having an open end oriented towards the bottom of the food bowl 3, as depicted in FIG. 10; the first leg mount 35 being designed to receive the first upright 41, the second leg mount 36 being designed to receive the second upright 44, the third leg mount 37 being designed to receive the third upright 51, and the fourth leg mount 38 being designed to receive the fourth upright 54.

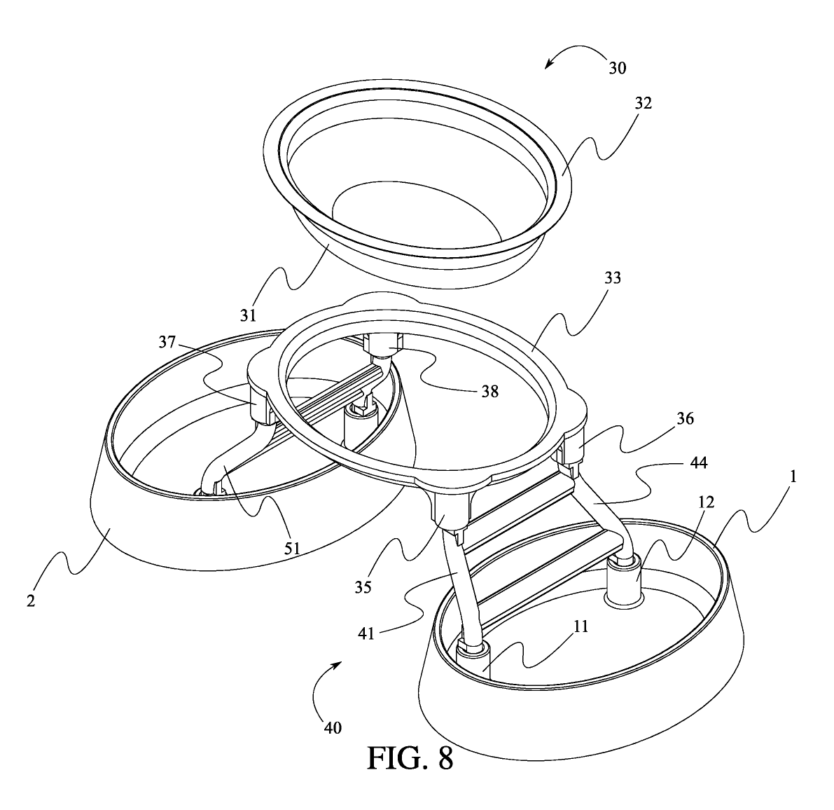

In reference to FIG. 8, in the preferred embodiment of the present invention, the food bowl 3 further comprises a food basin 30 and a basin retainer ring 33. The food basin 30 provides a removable receptacle that is used to hold the pet food, while the basin retainer ring 33 supports the food basin 30 atop of the elevation stand 4. In the preferred embodiment of the present invention, the basin retainer ring 33 has an ovular opening and the food basin 30 is ovular in shape; however, the food basin 30 and the basin retainer ring 33 may be shaped differently in other embodiments. The basin retainer ring 33 is mounted onto the first leg structure 40 and the second leg structure 50, wherein the first leg structure 40 and the second leg structure 50 are positioned opposite each other about the basin ring retainer. The food basin 30 is positioned through the basin retainer ring 33, wherein a portion of the food basin 30 engages with the basin retainer ring 33 such that the food basin 30 is suspended by the basin retainer ring 33.

More specifically, the food basin 30 comprises a basin body 31 and a support rim 32. The basin body 31 is the main body of the food basin 30 and provides the concave structure that is used to retain the pet food. Meanwhile, the support rim 32 is a lateral protrusion that perimetrically connected to the basin body 31, about the upper edge of the basin body 31. The basin body 31 is shaped to conform with the opening of the basin retainer ring 33, such that the basin body 31 may be slotted into the basin retainer ring 33. When the basin body 31 is positioned through the basin retainer ring 33, the support rim 32 engages with the basin retainer ring 33, wherein the support rim 32 prevents the food basin 30 from completely traversing through the basin retainer ring 33. The support rim 32 rests on top of the basin retainer ring 33, as depicted in FIG. 1, and supports the weight of the basin body 31 and the pet food placed therein.

The plurality of leg mounts 34 is radially integrated into the basin retainer ring 33, as depicted in FIG. 10, wherein the plurality of leg mounts 34 allows the basin retainer ring 33 to be mounted onto the first leg structure 40 and the second leg structure 50. The first leg mount 35 and the second leg mount 36 are disposed to one side of the basin retainer ring 33, while the third leg mount 37 and the fourth leg mount 38 are disposed to the opposing side of the basin retainer ring 33, as depicted through FIG. 4-5. The first leg mount 35 and the second leg mount 36 are transversely offset from each other, as shown in FIG. 6, while the third leg mount 37 and the fourth leg mount 38 are also transversely offset from each other, as shown in FIG. 7. This allows for the equal weight distribution of the food basin 30, both across and along the basin retainer ring 33.

In reference to FIG. 1, the first leg structure 40 is positioned into the first leg mount 35 and the second leg mount 36; more specifically, the first upright 41 is positioned into the first leg mount 35, while the second upright 44 is positioned into the second leg mount 36. In some embodiments of the present invention, the first upright 41 comprises a first mount stop 43, while the second upright 44 comprises a second mount stop 46, as depicted in FIG. 9. The first mount stop 43 is an extrusion that is offset from the end of the first upright 41 that is inserted into the first leg mount 35. As the first upright 41 is positioned into the first leg mount 35, the first mount stop 43 engages with the bottom of the first leg mount 35, preventing the first upright 41 from being inserted any further. Similarly, the second mount stop 46 is an extrusion that is offset from the end of the second upright 44 that is inserted into the second leg mount 36. As the second upright 44 is positioned into the second leg mount 36, the second mount stop 46 engages with the bottom of the second leg mount 36, preventing the second upright 44 from being inserted any further.

In reference to FIG. 2, the second leg structure 50 is positioned into the third leg mount 37 and the fourth leg mount 38; more specifically, the third upright 51 is positioned into the third leg mount 37, while the fourth upright 54 is positioned into the fourth leg mount 38. In some embodiments of the present invention, the third upright 51 comprises a third mount stop 53, while the fourth upright 54 comprises a fourth mount stop 56, as depicted in FIG. 9. The third mount stop 53 is an extrusion that is offset from the end of the third upright 51 that is inserted into the third leg mount 37. As the third upright 51 is positioned into the third leg mount 37, the third mount stop 53 engages with the bottom of the third leg mount 37, preventing the third upright 51 from being inserted any further. Similarly, the fourth mount stop 56 is an extrusion that is offset from the end of the fourth upright 54 that is inserted into the fourth leg mount 38. As the fourth upright 54 is positioned into the fourth leg mount 38, the fourth mount stop 56 engages with the bottom of the fourth leg mount 38, preventing the fourth upright 54 from being inserted any further.

In some embodiments of the present invention, the ends of each of the first upright 41, the second upright 44, the third upright 51, and the fourth upright 54 may be contoured to be more easily inserted into the first leg retainer 11 and the first leg mount 35, the second leg retainer 12 and the second leg mount 36, the third leg retainer 23 and the third leg mount 37, and the fourth leg retainer 24 and the fourth leg mount 38, respectively. The ends of the first upright 41, the second upright 44, the third upright 51, and the fourth upright 54 may be chamfered, filleted, or otherwise contoured to be easily received by the respective leg retainer and leg mount. The contoured nature of the ends of the first upright 41, the second upright 44, the third upright 51, and the fourth upright 54 allows for the assembly of the present invention, without the components initially being precisely aligned with one another. This allows for quicker and easier assembly of the present invention.

In some embodiments, the present invention may further comprise one or more pumps to circulate the water within the first water bowl 1 and the second water bowl 2. This prevents the water from being stagnant, thus providing cleaner water for the pet to drink. For example, in one embodiment a first pump may be integrated with the first water bowl 1, while a second pump is integrated with the second water bowl 2; the first pump and the second pump operating independent of one another. In another embodiment, a single pump may be integrated with both the first water bowl 1 and the second water bowl 2. An intermediary fluid conduit, fluid chamber, or similar structure can be used to connect the first water bowl 1 and the second water bowl 2, such that the single pump is able to generate a water flow in both the first water bowl 1 and the second water bowl 2. The single pumped could be installed in the first water bowl 1, the second water bowl 2, or the fluid chamber/fluid conduit in order to generate the water flow.

In some embodiments of the present invention, the first water bowl 1 and the second water bowl 2 may be substantially elevated from the resting surface. This is of particular benefit to larger pets, so that they pet does not need to hunch over as much to reach the food bowl 3, or either of the first water bowl 1 or the second water bowl 2. The first water bowl 1 and the second water bowl 2 can be raised by simply extending the bottom edge of the first water bowl 1 and the second water bowl 2, while retaining the same depth to the concave portion of the first water bowl 1 and the second water bowl 2. In some embodiments, the present invention may comprise a first riser and a second riser, wherein the first riser may be removably attached to the first water bowl 1 and the second riser may be removably attached to the second water bowl 2. The first riser is snapped onto, or otherwise attached to, the bottom of the first water bowl 1. Similarly, the second riser is snapped onto, or otherwise attached to, the bottom of the second water bowl 2. This allows the height of the present invention to be adjusted for use by multiple pets.

In some embodiments of the present invention, the elevation stand 4 may further comprise a third bridge. The third bridge provides an additional truss member to support the food bowl 3 and provide stability to the present invention. The third bridge is positioned in between the first bridge 47 and the second bridge 57, wherein the first bridge 47 and the second bridge 57 are terminally connected to opposing ends of the third bridge.

In some embodiments of the present invention, the first water bowl 1, the second water bowl 2, the elevation stand 4, and the food bowl 3 are all removably attached to one another. This allows the present invention to be easily broken down and transported, stored, etc. In other embodiments of the present invention, the first water bowl 1, the second water bowl 2, the elevation stand 4, and the food bowl 3 may all be permanently connected to one another. This enhances the stability of the present invention, as it is not possible for one component to be inadvertently detached from another. In yet other embodiments of the present invention, some of the first water bowl 1, the second water bowl 2, the elevation stand 4, and the food bowl 3 may be permanently connected to each other, while others may be removably attached to each other. For example, the elevation stand 4 may be permanently connected to the first water bowl 1 and the second water bowl 2 to provide a more stabilized base, while the food bowl 3 is removably attached to the elevation stand 4, allowing the food bowl 3 to be more easily cleaned.

Although the invention has been explained in relation to its preferred embodiment, it is to be understood that many other possible modifications and variations can be made without departing from the spirit and scope of the invention as hereinafter claimed.

What is claimed is:

1. A pest free pet feeder comprises:
a first water bowl;
a second water bowl;
a food bowl;
an elevation stand comprising a first leg structure and a second leg structure;
the first leg structure being positioned into the first water bowl;
the first water bowl being terminally attached to the first leg structure;
the second leg structure being positioned into the second water bowl;
the second water bowl being terminally attached to the second leg structure;
the food bowl being terminally attached to the first leg structure, opposite the first water bowl;
the food bowl being terminally attached to the second leg structure, opposite the second water bowl;
the food bowl being positioned in between the first water bowl and the second water bowl; and
the first leg structure and the second leg structure being positioned opposite each other about the food bowl.

2. The pest free pet feeder as claimed in claim 1 comprises:
the first water bowl comprising a first leg retainer and a second leg retainer;
the first leg retainer and the second leg retainer being longitudinally offset from each other; and
the first leg structure being mounted into the first leg retainer and the second leg retainer.

3. The pest free pet feeder as claimed in claim 2 comprises:
the first leg structure comprising a first upright and a second upright;
the first upright being positioned into the first leg retainer; and
the second upright being positioned into the second leg retainer.

4. The pest free pet feeder as claimed in claim 1 comprises:
the first leg structure comprising a first upright, a second upright, and a first bridge;
the first upright and the second upright being terminally connected to the first bridge; and
the first upright and the second upright being positioned opposite each other along the first bridge.

5. The pest free pet feeder as claimed in claim 1 comprises:
the food bowl comprising a first leg mount and a second leg mount;
the first leg mount and the second leg mount being transversely offset from each other; and
the first leg structure being positioned into the first leg mount and the second leg mount.

6. The pest free pet feeder as claimed in claim 5 comprises:
the first leg structure comprising a first upright and a second upright;
the first upright being positioned into the first leg mount; and
the second upright being positioned into the second leg mount.

7. The pest free pet feeder as claimed in claim 1 comprises:
the second water bowl comprising a third leg retainer and a fourth leg retainer;
the third leg retainer and the fourth leg retainer being longitudinally offset from each other; and
the second leg structure being mounted into the third leg retainer and the fourth leg retainer.

8. The pest free pet feeder as claimed in claim 7 comprises:
the second leg structure comprising a third upright and a fourth upright;
the third upright being positioned into the third leg retainer; and
the fourth upright being positioned into the fourth leg retainer.

9. The pest free pet feeder as claimed in claim 1 comprises:
the second leg structure comprising a third upright, a fourth upright, and a second bridge;
the third upright and the fourth upright being terminally connected to the second bridge; and
the third upright and the fourth upright being positioned opposite each other along the second bridge.

10. The pest free pet feeder as claimed in claim 1 comprises:
the food bowl comprising a third leg mount and a fourth leg mount;
the third leg mount and the fourth leg mount being transversely offset from each other; and
the second leg structure being positioned into the third leg mount and the fourth leg mount.

11. The pest free pet feeder as claimed in claim 10 comprises:
the second leg structure comprising a third upright and a fourth upright;
the third upright being positioned into the third leg mount; and
the fourth upright being positioned into the fourth leg mount.

12. The pest free pet feeder as claimed in claim 1 comprises:
the food bowl comprising a food basin and a basin retainer ring;
the basin retainer ring being mounted onto the first leg structure and the second leg structure;
the food basin being positioned through the basin retainer ring; and
the food basin being suspended by the basin retainer ring.

13. The pest free pet feeder as claimed in claim 12 comprises:
the food basin comprising a basin body and a support rim;
the support rim being perimetrically connected to the basin body;
the basin body being positioned through the basin retainer ring; and
the support rim being engaged with the basin retainer ring.

14. The pest free pet feeder as claimed in claim 12 comprises:
the food bowl further comprising a plurality of leg mounts; and
the plurality of leg mounts being radially integrated into the basin retainer ring.

15. The pest free pet feeder as claimed in claim 14 comprises:
the plurality of leg mounts consisting of a first leg mount, a second leg mount, a third leg mount, and a fourth leg mount.
